(19) United States
(12) Patent Application Publication
(10) Pub. No.: US 2010/0037984 A1
(43) Pub. Date: Feb. 18, 2010

(54) ASEPTIC FILLING DEVICE FOR CARBONATED BEVERAGES

(75) Inventors: Kiyoshi Hiroya, Nakamura-ku (JP); Kenji Mizukawa, Nakamura-ku (JP); Hirofumi Sato, Tokyo (JP); Shingo Wada, Tokyo (JP); Tsuyoshi Akimoto, Tokyo (JP); Yoshihisa Tachibana, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: The Coca-Cola Company; Mitsubishi Heavy Industries Food & Packaging Machinery Co., Ltd.

(21) Appl. No.: 12/189,987

(22) Filed: Aug. 12, 2008

(51) Int. Cl. B65B 31/04; B67C 3/00; B65B 55/02

(52) U.S. Cl. 141/59; 141/37; 141/64; 53/425; 53/432

(57) ABSTRACT

An aseptic filling device for filling carbonate beverages capable of decreasing the size of the clean booth, facilitating maintenance around the filling valve, and reliably sterilizing the interior of gas piping is provided. The aseptic filling device includes a plurality of filling valves, a fluid rotary joint, a filling fluid tank, a fluid surface level sensor, a fluid flow adjustment valve, a container gripper, a plurality of exhaust conduits, an exhaust conduit on/off valve, a plurality of counter gas conduits, a counter gas conduit on/off valve, a rotary joint, an ascetic gas conduit, a flow meter, and a sterilizing filter, wherein rotary conveyed containers contact at least one of the filling valves and are sealed by a sealing member. Filling is performed under a gas pressure, for example, carbon dioxide gas pressure, and a sterilizing filter for sterilizing the gas is mounted on a gas pipe connecting the rotary joint and the filling fluid tank.

### TECHNICAL FIELD

Disclosed herein are aseptic filling devices used in filling a beverage or the like into containers from a pressurized tank, and in particular, aseptic filling devices that maintain a beverage or the like and carbonated gas processed by a filling valve in an aseptic state and surround the filling valve with pressurized aseptic gas or air. Background

JP 2003-040396 depicts a conventional rotary aseptic filling device. An upper portion of the device includes a ring-shaped filler bowl and a lower portion includes a rotary joint. A filling fluid is supplied to the ring-shaped filler bowl through the rotary joint. The filling fluid is distributed to filling valves from the filler bowl. A seal is made between the inside perimeter rotating portion enclosure and the outside perimeter fixed portion enclosure, thereby blocking the exchange of gases between the interior and the exterior to form an aseptic chamber. Contained within the aseptic chamber is a container mount capable of mounting vertically moving beverage containers, a filling nozzle, and a conveyance means for conveying beverage containers. The filling valves are old fashioned, internal pressure-balanced, fluid level-setting-type filling valves, and are complex, costly, and cumbersome to maintain. Adequate sterilization of carbon dioxide gas in the gas piping conduit may also be an issue.

JP 2004-315045 depicts another aseptic filling device wherein a filling device main unit is housed within a clean booth. Filling fluid and pressurized carbon dioxide gas, substituted for air inside the beverage container during filling, is supplied from a filling liquid holding tank mounted outside the clean booth on the filling device main unit through a rotary joint placed at the top of the filling device main unit. Exhaust carbon dioxide gas is exhausted to the outside of the device from a lower portion rotary joint place at the bottom of the filling device main unit. The filling fluid tank is installed outside the structure increasing the installation surface area. Also, the clean booth covering the filling device main unit is large, and the filling fluid tank is positioned below the filling valve or the fluid supply portion. A risk may develop that gas generated within the piping will stay within the piping, and filling fluid will accumulate within the piping.

JP 2005-014918 depicts an aseptic filling device similar to a device depicted in JP 2004-315045, but in JP 2005-014918, the device includes a sub-chamber covering the rotary joint, which is exposed at the top of the clean booth covering the filling device main unit.

Therefore, a need remains to develop an aseptic filling device that reduces the risk of gas and filling fluid accumulation in the piping and improves the efficiency of maintaining and sterilizing the device the addresses the above problems is desired.

### SUMMARY

Disclosed herein are aseptic filling devices for carbonated beverages. In one aspect, the device includes a plurality of filling valves mounted at equal, or substantially equal, intervals on a fixed perimeter of a rotating body and furnished with sealing member. The device includes a plurality of filling fluid conduits and a plurality of fluid valves to open and close the filling fluid conduits. A fluid rotary joint is attached on its fixed side to a fixed piece and on its rotating side to a rotating body.

Filling fluid from a filling fluid tank is supplied to the plurality of filling valves via a plurality of fluid supply pipes. The level of the filling fluid tank can be monitored with a fluid level sensor mounted within the filling fluid tank. A fluid flow quantity adjustment valve can be installed on the filling fluid piping between the fluid rotary joint to the filling fluid tank for adjusting the flow of filling fluid using a signal from the fluid level sensor.

A container gripper furnished with a container lift conveys at least one container such that the at least one container is at a location to receive filling fluid from the filling valve.

A plurality of exhaust conduits configured to exhaust gas within the containers is mounted on the plurality of filling valves. An exhaust conduit on/off valve opens and closes the exhaust conduits. A plurality of counter gas conduits mounted on the plurality of filling valve supplies pressurized gas to the beverage containers. A counter gas conduit on/off valve opens and closes the counter gas conduits. An aseptic gas rotary joint fluidly connects the exhaust conduit, the counter gas conduit, and the external aseptic gas supply portion and exhaust portion. An aseptic gas conduit connects the carbon dioxide gas rotary joint and the filling fluid tank, a flow meter measures the amount of filling fluid flowing in each of the respective filling fluid conduits on the filling valves.

In a filling mode whereby containers are filling with filling fluid, the rotary conveyed containers contact the filling valves and are sealed by a sealing member. Filling is performed under gas pressure, for example, carbon dioxide gas pressure. A sterilizing filter for sterilizing the gas is placed on the carbon dioxide gas conduit connecting the rotary joint and the filling fluid tank.

It is to be understood that both the foregoing general description and the following detailed description are exemplary and explanatory only and are not restrictive of the invention, as claimed.

### BRIEF DESCRIPTION OF THE DRAWINGS

FIG. 1 depicts a plan view flow of containers conveyed between an aseptic filling machine for carbonated beverages and peripheral machinery, as well as the scope of what is surrounded by a clean booth;

FIG. 2 is a piping system and instrument diagram of the filling fluid, carbon dioxide gas, and the like flowing between the elemental parts of the aseptic filling machine of FIG. 1;

FIG. 3 is a side view cross-sectional diagram showing the outline of the filling valve periphery and clean booth of the aseptic filling machine of FIG. 1; and

FIG. 4 is a piping system and instrument diagram showing the operating states of on/off valves on pipes for filling fluid, carbon dioxide gas, and the like when cleaning the aseptic filling machine of FIG. 1.

### DETAILED DESCRIPTION

Disclosed herein is a filling device used for filling containers with fluids, for example, carbonated beverages. The filling device is capable of decreasing the size of the clean booth, thereby reducing costs, and facilitating maintenance around the filling device and sterilization of the inner surfaces of gas pipes. A back pressure can be applied to a filling fluid storage portion by an aseptic gas or air, for example, carbon dioxide gas. Also disclosed are embodiments for a filling device wherein filling fluid and gas or air processed by a filling valve are in an aseptic state, and the perimeter of the filling valve is surrounded by aseptic pressurized gas or aseptic pressured air.

In one embodiment, the aseptic filling device includes a plurality of filling valves mounted at equal, or substantially equal, intervals on the fixed perimeter of a rotating body. The aseptic filling device can be furnished with a sealing member having filling fluid conduits and fluid valves to open and close the conduits. A fluid rotary joint is attached on its fixed side to a fixed piece and on its rotating side to a rotating body. A filling fluid tank is connected to a plurality of fluid supply pipes, which are connected to the plurality of filling valves installed at the top of the rotating body. A fluid level sensor mounted within the filling fluid tank detects the level of the filling fluid therein. Responsive to a signal from a fluid level sensor, a fluid flow quantity adjustment valve mounted on the filling fluid piping connecting the fluid rotary joint to the filling fluid tank can adjust the flow of filling fluid. A container gripper furnished with a container lift is configured to convey at least one container to a location to receive filling fluid. In an embodiment, a container is located directly below a filling valve. In another embodiment, a container is located off-center relative to a filling valve yet still in a location where it can receive dispensed filling fluid.

The aseptic filling device can include one or more conduits configured to supply exhaust gas or air. In one embodiment, an exhaust conduit can be mounted on each filling valve for exhausting gas within the containers. To isolate the exhaust conduit, an exhaust conduit on/off valve for opening and closing the conduit can be installed in the conduit. In one embodiment, an exhaust conduit on/off valve can be positioned within one exhaust conduit. In another embodiment, an exhaust conduit on/off valve may be positioned in an exhaust conduit feeder pipe. A counter gas conduit can be mounted on each filling valve for supplying pressurized gas into the containers. A counter gas conduit on/off valve for opening and closing the counter gas conduit can also be provided in the conduit. In one embodiment, a counter gas on/off valve is positioned within one counter gas conduit. In another embodiment, a counter gas on/off valve is position in a counter gas feeder pipe.

In a further embodiment, the conduits and the supply lines can be fluidly connected by an aseptic gas rotary joint. For brevity, the aseptic gas may be referred to as carbon dioxide, but the skilled artisan would understand that any gas or air that can function aseptic. The joint can connect the exhaust conduit, the counter gas conduit, the external carbon dioxide gas supply portion and exhaust portion. A carbon dioxide gas conduit can connect the carbon dioxide gas rotary joint and the filling fluid tank. A flow meter for measuring the amount of filling fluid flowing in each of the respective filling fluid conduits on the filling valves can be installed in each conduit. In a filling mode, rotary conveyed containers contact the filling valve and are sealed by a sealing means, and filling is performed under carbon dioxide gas pressure. A sterilizing filter for sterilizing carbon dioxide gas can be placed on the carbon dioxide gas conduit connecting the rotary joint and the filling fluid tank.

The filling fluid tank is positioned within a main unit so that the filling device main unit is large, but the overall system is compact, and maintenance and inspection are easily accomplished. Since the piping conduit ends inside the filling fluid main unit, limitations on the piping system caused by placement location of the filling machine are minimized. Since a sterilizing filter is disposed in the carbon dioxide gas piping from the rotary joint to the filling fluid tank, the carbon dioxide gas conduit in the rotary joint may not be included with the aseptic specification, thereby simplifying the structure and reducing costs.

In a further embodiment, the aseptic filling device is mounted on the bottom of the filling fluid tank using the rotary body rotary axis as its center axis, and the filling fluid conduit extends upward to connect with the filling fluid tank. The filling fluid tank contained within the filling machine main unit is disposed above the filling valve or the rotary joint which serves as the fluid supply portion, therefore gas generated within the piping rises within the piping and is advanced above the fluid level of the filling fluid tank, such that there is a reduced risk of the filling fluid accumulating in the piping. The fluid path from the rotary joint to the filling fluid tank is directed upward, so accumulation of fluid in the fluid conduit is minimized when removing product fluid or cleaning fluid, and cleaning in place (hereinafter “CIP”) is more easily accomplished.

In an embodiment useful for, but not limited to, a CIP mode, the filling valve and container gripper can be housed within a clean booth sealed off from the outside air. A container supply intake portion to the filling device is connected to a cleaning portion, and a container ejection portion is adapted to the shape of the container, thereby sealing off the perimeter of the filling device filling valve from outside air. In an embodiment, the clean booth is sealed off such that a clean but non-sterile environment is maintained. In yet another embodiment, the clean booth is sealed off such that a sterile environment is maintained.

A shower nozzle is disposed at the top of the filling fluid tank, cleaning fluid piping for sanitizing the shower nozzle is connected thereto and is connected to the filling fluid piping, and a switching valve is provided on the filling fluid piping for switching between filling fluid and cleaning fluid when the filling device transitions from a filling mode to a cleaning mode.

Reference will now be made in detail to various exemplary embodiments of the invention, examples of which are illustrated in the accompanying drawings. Wherever possible, the same reference numbers will be used throughout the drawings to refer to the same or like parts.

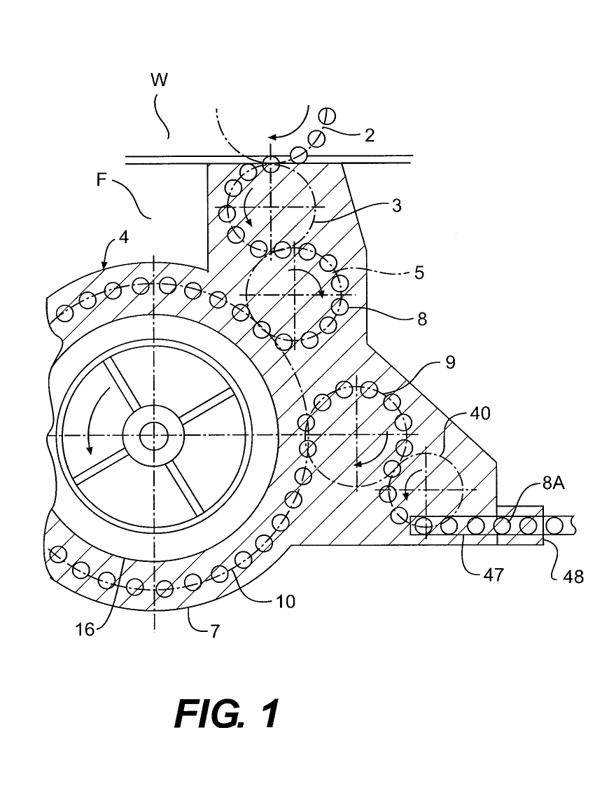

FIG. 1 depicts the conveyance flow of PET bottles in an aseptic filling device for carbonated beverages according to one embodiment. Empty PET bottles 8 are washed and sterilized in a cleaning portion W, passed from a conveyance star wheel 2 to a filling portion F star wheel 3, and then fed into an aseptic filling machine for carbonated beverages 10 via a star wheel 5. A filled PET bottle 8A filled with carbonated beverage by aseptic filling machine 10 is passed to a star wheel 9, then sent from star wheel 9 to a capping machine 40, capped in capping machine 40, and sealed. The gas-containing beverage-filled PET bottle 8A is conveyed outside of the machine by a conveyor 47.

The flowpath of PET bottles 8 and 8A from the border between cleaning portion W and filling portion F to conveyor 47 is covered by a clean booth 4. Clean booth 4, represented by the hatched portion, is fed by pressurized aseptic gas or air. In order to reduce or prevent the penetration of outside air, filled PET bottles 8A exit through an opening 48 sized to allow filled PET bottle 8A to pass.

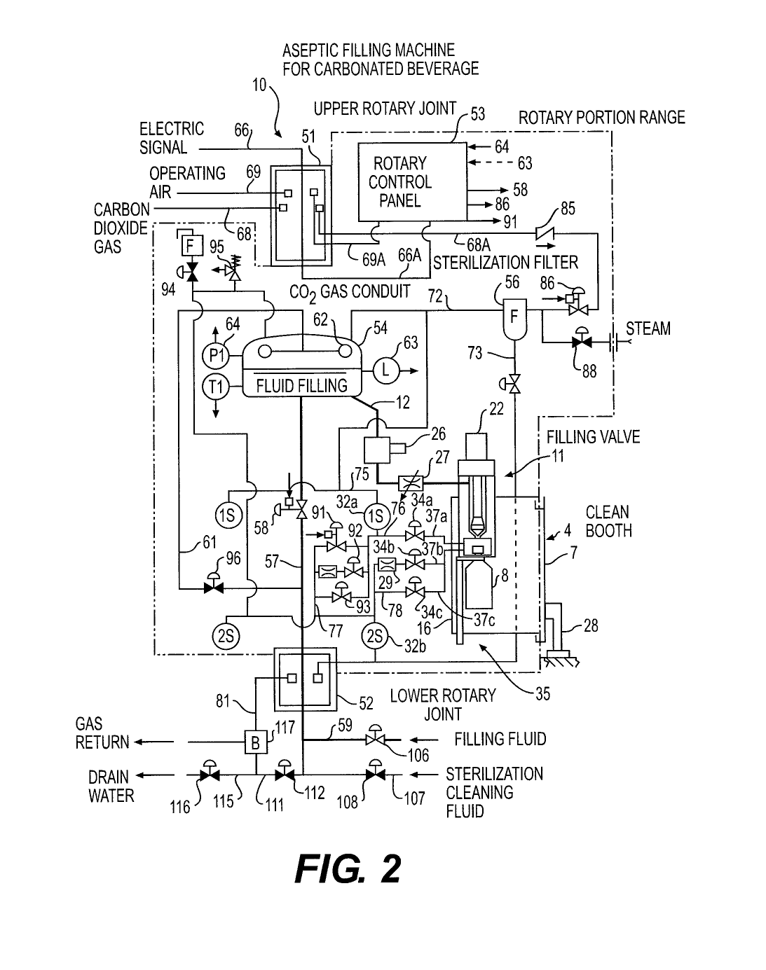

Turning now to the embodiment depicted in FIG. 2, carbon dioxide gas is used as the counter gas. However, other pressurized aseptic gases or air can be used. An upper rotary joint 51 connected to both a fixed piece and a rotary body is installed at the top portion of aseptic filling machine 10. A fixed-side electrical signal wire 66, an operating air pipe 69, and a carbon dioxide gas pipe 68 are connected to upper rotary joint 51 on the fixed side. An electrical signal wire 66A and an operating air pipe 69A on the rotary side of upper rotary joint 51 are connected to a rotary control panel 53 mounted on the rotary side of aseptic filling machine 10. A carbon dioxide gas pipe 68A, in which gas pressure is adjusted by a gas pressure adjustment valve 86, serves as a carbon dioxide gas pipe 72 and is fed to a filling fluid tank 54 and a plurality of filling valves 11 (one shown; hereinafter “filling valve 11”). A sterilizing filter 56 for sterilizing carbon dioxide gas is mounted on carbon dioxide gas pipe 72 between upper rotary joint 51 and filling fluid tank 54. When sterilizing filter 56 is positioned between upper rotary joint 51 and filling fluid tank 54, the carbon dioxide gas conduit in upper rotary joint 51 does not have to be of an aseptic specification, thereby simplifying structure and reducing cost. In another embodiment (not shown), carbon dioxide gas pipe 72 feeds filling filter tank 54 without first passing through a sterilizing filter. Positioned upstream of sterilizing filter 56, a check valve 85 prevents the reverse flow of carbon dioxide gas.

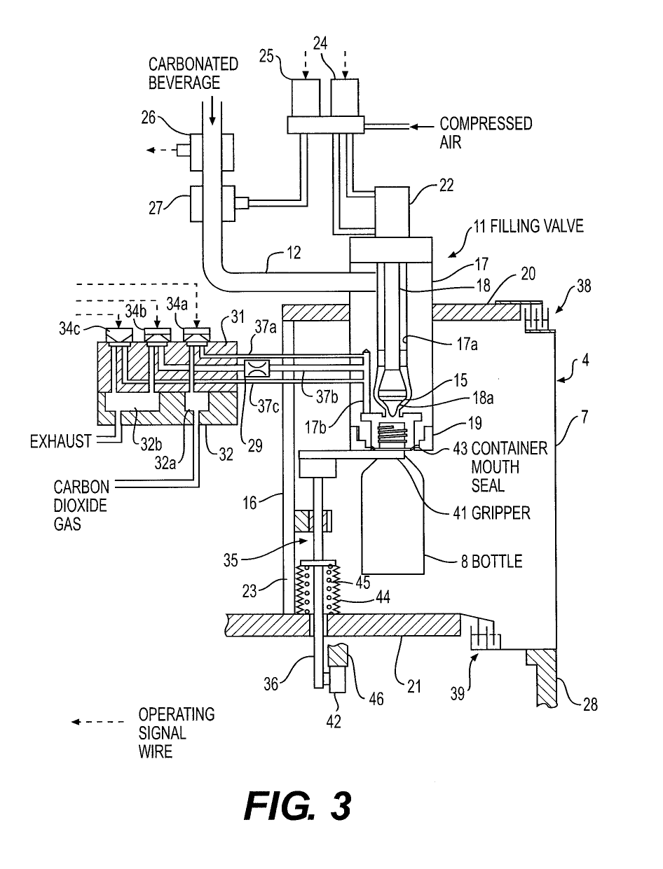

A pressure adjustment valve 91 is mounted on a pipe 76 connecting to carbon dioxide gas pipe 72, a pipe 75, and a carbon dioxide gas conduit 32a (shown in more detail in FIG. 3). Pressure adjustment valve 91 is connected to a gas exhaust conduit 32b, which is a return gas pipe, through a pipe 77. A gas pressure sensor 64 detects gas pressure in filling fluid tank 54. The sensed gas pressure is compared to a set pressure, and when higher than the set pressure, the pressure of the carbon dioxide gas supplied to filling fluid tank 54 is adjusted to approach the pressure of the set pressure. Conversely, when the gas pressure detected by gas pressure sensor 64 is lower than the set gas pressure on filling fluid tank 54, an instruction is issued from the rotary control panel 53, and the gas pressure adjustment valve 86 controls the gas pressure so that it rises to the set pressure.

On/off valves 92, 93 are used when carbon dioxide gas is removed for sterilization cleaning. Pressure safety valve 95 is used to avoid overpressure within the piping system before commencing with the filling mode or when stopping the filling mode.

A lower rotary joint 52 connected to a fixed piece and a rotary body is mounted on the lower portion of aseptic filling machine 10. Filling fluid rises vertically from an external fixed pipe 59 through lower rotary joint 52 in a filling fluid supply piping 57. Filling fluid supply piping 57 passes through the center of aseptic filling machine 10, thereby flowing into filling fluid tank 54 mounted at the top thereof. An on/off valve 106 and 108 is used when switching over to the sterilizing washing fluid supplied by an on/off valve 107.

Gas exhaust conduit 32b is also connected to the lower rotary joint 52. Return gas is exhausted to a gas return pipe 81.

A gas/water separator 117 receives the filtered by-product from sterilizing filter 56. An on/off valve 116 is mounted on a water drain pipe 115 branching off from gas/water separator 117. A branch pipe 111 is mounted between a sterilization cleaning fluid supply pipe 107 and the water drain pipe 115, and branch pipe 111 is provided with an on/off valve 112.

A plurality of fluid supply pipes 12 (one shown, hereinafter “fluid supply pipe”) is attached to filling fluid tank 54. Fluid supply pipe 12 distributes filling fluid to filling valve 11.

A fluid surface level sensor 63 for detecting the fluid surface height of the filling fluid is mounted inside filling fluid tank 54. A fluid flow adjustment valve 58 mounted on a filling fluid supply piping 57 adjusts the filling fluid flow in response to a signal from fluid surface level sensor 63 to control the height of the filling fluid within filling fluid tank 54 to be within the set range.

Turning now to FIG. 3, filling valve 11 having a fluid valve 18 for opening and closing a filling fluid conduit 17a are disposed at equal, or substantially equal, intervals on the fixed perimeter of an upper rotary plate 20. Grippers to hold PET bottles 8 are provided at the lower portion of filling valve 11. PET bottles 8 are positioned directly under filling valve 11, and a container lift 35 for moving PET bottles 8 vertically is provided in order to bring PET bottles 8 into contact with filling valve 11.

The carbon dioxide gas which serves as the counter gas replaces the air in PET bottles 8. Carbon dioxide gas conduit 37a supplies pressurized gas to PET bottles 8. A carbon dioxide gas conduit on/off valve 34a opens and closes the carbon dioxide gas conduit. An exhaust conduit on/off valve 34c opens and closes an exhaust conduit 37c. A snift gas conduit 37b for snifting subsequent to the filling of filling fluid into the PET bottles 8, a throttle valve 29 mounted on snift gas conduit 37b, and a snift gas conduit on/off valve 34b for opening and closing snift gas conduit 37b are also provided.

Filling valve 11 is supported by upper rotary plate 20. Connected to a main unit 17 of filling valve 11 is fluid supply pipe 12 for supplying the carbonated beverage, also referred to as filling fluid, the carbon dioxide gas conduit 37a, snift gas conduit 37b, and exhaust conduits 37c for exhausting air expelled from within PET bottles 8 and carbon dioxide gas substituted for that air. Supply pipe 12 is supplied with a flow meter 26 for measuring the amount of carbonated beverage supplied and a flow switchover valve 27 capable of adjusting the fluid amount.

An air cylinder 22 is attached at the top of main unit 17, and a fluid valve 18 is affixed to air cylinder 22 drive rod portion. Fluid valve 18 is such that in an electromagnetic valve 24, compressed air conduits are switched by an operating signal from the control device (not shown), air cylinder 22 is driven, and filling fluid conduit 17a is opened and closed. Seal packing 15 fits into a groove with a tapered shape 18a formed in fluid valve 18.

When PET bottle 8 is placed in contact with a container mouth seal 43 provided at the lower opening portion of filling valve 11, fluid valve 18 is opened by driving air cylinder 22, and PET bottle 8 is filled with carbonated beverage. The flow switchover valve 27 is first opened to the large flow volume side by the operation of an electromagnetic valve 25. Flow is then switched to a small flow volume as the filling progresses, before the filling volume reaches the capacity of PET bottle 8. When the cumulative flow volume reaches the set value, air cylinder 22 is operated in reverse to close fluid valve 18. A nut 19 is used to attach container mouth seal 43 to main unit 17.

Carbon dioxide gas conduit 37a, snift gas conduit 37b, and exhaust conduit 37c are respectively joined to main unit 17. Carbon dioxide gas conduit 37a, snift gas conduit 37b, and exhaust conduit 37c fluidly communicate with a gas pipe 17b connecting with the filling fluid conduit 17a in main unit 17. Each of the respective gas conduits 37a, 37b, and 37c is opened and closed by the on/off valves 34a, 34b, and 34c attached to an on/off valve block 31. On/off valve block 31 is attached to a ring-shaped gas conduit block 32, and gas conduit block 32 is furnished with a carbon dioxide gas conduit 32a and a gas exhaust conduit 32b.

Container gripper 41, having gripped PET bottle 8, is moved vertically by container lift 35, bringing PET bottle 8 into contact with container mouth seal 43 at the lower side of filling valve 11. Container lift 35 is attached to lower rotary plate 21, which is made as a single piece using the upper rotary plate 20 and a vertical through piece 23, and rotates together with filling valve 11. A lift shaft 36 for container lift 35 is furnished with a cam follower 42. When aseptic filling machine 10 rotates an external fixed cam 46, container gripper 41 is lifted or lowered at a prescribed angular position.

An internal surround 16 is attached along vertical through piece 23 on the inside perimeter side of upper rotary plate 20 and lower rotary plate 21. A downward pointing labyrinth plate, which serves as a gas seal by being soaked in water seal labyrinths 38, 39 of an external surround 7 affixed to an external affixing piece 28, is attached to the external perimeter side of upper rotary plate 20 and lower rotary plate 21. A pressure greater than atmospheric pressure is constantly applied to clean booth 4 surrounded by upper rotary plate 20, lower rotary plate 21, internal surround 16, and external surround 7. A compression spring 45 disposed between lower rotary plate 21 and container lift 35 has the purpose of applying an upward pressure on container lift 35, and a bellows 44 has the purpose of blocking off the interior of clean booth 4.

Portions touched by the filling fluid and the carbon dioxide gas serving as process gas, such as fluid supply pipe 12 to filling valve 11, filling valve 11, main unit 17 filling fluid conduit 17a, the fluid valve 18, gas conduits 37a, 37b, 37c, and the seal surface of filling valve 11 contacting PET bottles 8, are sterilized by the CIP described below. The cleaning fluid and steam used for CIP are removed from each of the piping systems. An on/off valve 106 is then opened, and filling fluid is fed to filling fluid tank 54 through filling fluid supply piping 57 and held. Gas pressure adjustment valve 86 is then opened and a counter pressure applied to the filling fluid in filling fluid tank 54, following which a sterilized PET bottle 8 is gripped by container gripper 41 and raised by container lift 35. The neck ring of PET bottle 8 is placed in contact with filling valve 11 and container mouth seal 43, sealed, and filled.

Carbon dioxide gas conduit 32a is opened, and aseptic carbon dioxide gas is fed to filling valve 11. Concurrently, exhaust conduit on/off valve 34c is opened, and air in PET bottle 8 is exhausted to gas return pipe 81 via gas exhaust conduit 32b and lower rotary joint 52. After the interior of PET bottle 8 is replaced by carbon dioxide gas, exhaust conduit on/off valve 34c is closed, the interior of PET bottle 8 is set at the same pressure as filling fluid tank 54, filling valve 11, fluid valve 18 is pulled upward, filling fluid conduit 17a is opened, and the filling fluid flow volume is detected by flow meter 26. If the cumulative volume has reached the set volume, fluid valve 18 is driven using air cylinder 22 to close filling fluid conduit 17a, snift gas conduit on/off valve 34b is opened, and the gas pressure in filling valve 11 seal space is snifted to atmospheric pressure and filling is completed.

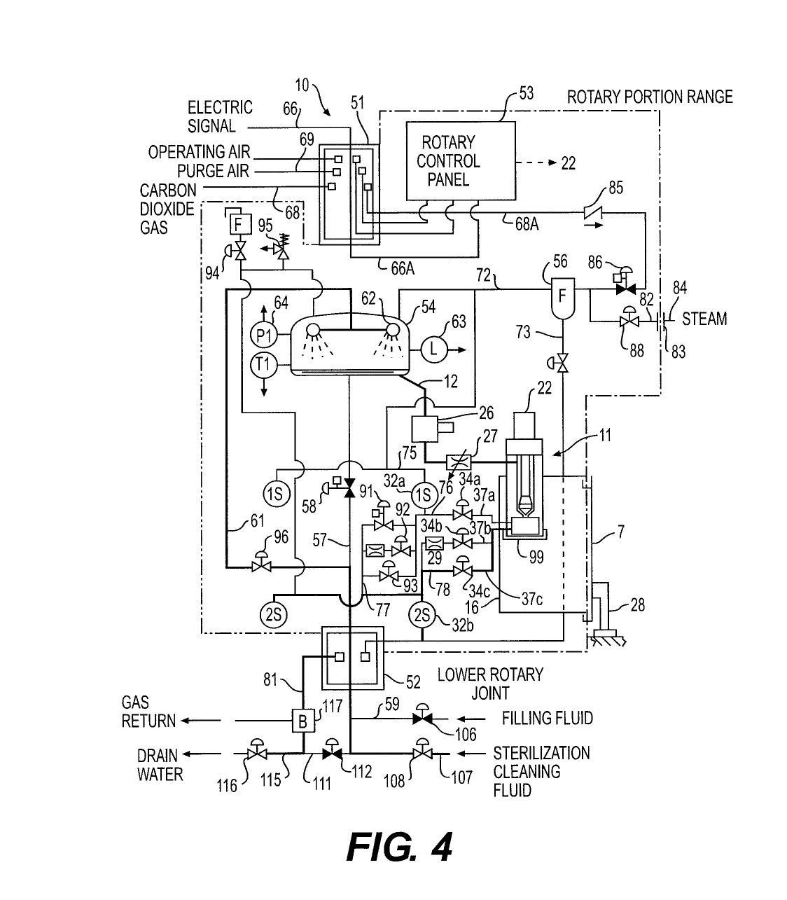

Turning now to FIG. 4, the CIP mode is carried out when aseptic filling machine 10 is not in the filling mode. On/off valve 106 on fixed pipe 59, which serves as the filling fluid supply pipe, is closed in response to an instruction from a control device (not shown). On/off valve 112 to branch pipe 111 is opened, and on/off valve 116 to water drain pipe 115 is opened. Filling fluid is removed from filling fluid supply piping 57 and filling fluid tank 54. Air cylinder 22 is operated to open fluid valve 18, and filling fluid is removed from fluid supply pipes 12 and filling valve 11. After which, a cover 99 is attached to the lower opening portion of filling valve 11, sealed, and container lift 35 is released under filling valve 11 together with container gripper 41. Gas pressure adjustment valve 86 is closed, and a sterilizing steam pipe 84 outside clean booth 4 is joined using a steam coupling 83 with a steam pipe 82 inside clean booth 4.

On/off valve 112 to branch pipe 111 is closed, an on/off valve 108 on the sterilization cleaning fluid supply pipe 107 is opened, and sterilizing cleaning fluid is fed to filling fluid supply piping 57 through lower rotary joint 52. Fluid flow adjustment valve 58 is closed and an on/off valve 96 is opened, avoiding direct inflow of sterilizing cleaning fluid to filling fluid tank 54. Cleaning fluid is fed from sterilizing cleaning fluid piping 61 to cleaning nozzle 62 inside filling fluid tank 54, thereby cleaning the interior of filling fluid tank 54.

Confirmation is made by fluid surface level sensor 63 that the sterilizing cleaning fluid has accumulated to an appropriate amount in filling fluid tank 54. Fluid valve 18 is raised and filling valve 11 is opened. When exhaust conduit on/off valve 34c to exhaust conduit 37c is opened, the sterilizing cleaning fluid passes through an exhaust pipe 78, gas exhaust conduit 32b, and lower rotary joint 52, then through gas return pipe 81, where it is separated by gas/water separator 117 into a gas component and hot water, each of which is expelled outside of the machine. At this point, on/off valve 116 to water drain pipe 115 is left open. The piping through which sterilizing cleaning fluid passes is depicted by thick solid lines.

Next, on/off valve 108 to sterilization cleaning fluid supply pipe 107 is closed, the supply of sterilizing cleaning fluid is stopped, fluid flow adjustment valve 58 and on/off valve 96 are opened, sterilizing cleaning fluid in filling fluid tank 54, fluid supply pipes 12, and filling valve 11 is expelled from fixed pipe 59 and gas return pipe 81. Bearings 94 and on/off valve 88 are opened, and steam is introduced from the steam pipe 82. Steam passes through sterilizing filter 56, all gas pipes, fluid pipes, and a condensate water pipe 73. Cleaning fluid, to which the remaining steam and water condensate have been added, is fed to gas return pipe 81 and separated into steam and hot water. The steam is fed to the gas return, and the hot water is expelled from water drain pipe 115 by opening on/off valve 116, thereby completing the CIP.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An aseptic filling device for carbonated beverages comprising
a plurality of filling valves mounted at substantially equal intervals on a fixed perimeter of a rotating body, a filling valve including a filling fluid conduit, a fluid valve for opening and closing the filling fluid conduit, and a sealing member for sealing the filling valve and a container;
a fluid rotary joint having a fixed part and a rotating part;
a filling fluid tank connected to a plurality of fluid supply pipes; the plurality of fluid supply pipes connected to the plurality of filling valves;
a fluid level sensor mounted within the filling fluid tank;
a fluid flow quantity adjustment valve installed in a filling fluid piping between the fluid rotary joint and the filling fluid tank and configured to adjust a flow of filling fluid using a signal from the fluid level sensor;
a container gripper furnished with a container lift for conveying at least one container, wherein the at least one container is positioned below the plurality of filling valves in a location to receive filling fluid;
a plurality of exhaust conduits mounted on the plurality of filling valves and configured to exhaust gas from the at least one container;
an exhaust conduit on/off valve for opening and closing the plurality of exhaust conduits;
a plurality of counter gas conduits mounted on the filling valve configured to supply pressurized gas into the container;
a counter gas conduit on/off valve configured to open and close the counter gas conduit;
an aseptic gas rotary joint connecting the plurality of exhaust conduits, the plurality of counter gas conduits, and an external aseptic gas supply and exhaust portion;
an aseptic gas conduit connecting the aseptic gas rotary joint and the filling fluid tank;
a flow meter for measuring the amount of filling fluid flowing in the filling fluid conduit; and
a sterilizing filter for sterilizing carbon dioxide gas positioned between the fluid rotary joint and the filling fluid tank on the carbon dioxide gas conduit.

2. The aseptic filling device according to claim 1, wherein the fluid rotary joint is mounted on the bottom of the filling fluid tank using a rotary body rotary axis as a center axis, and the filling fluid conduit extends upward to connect with the filling fluid tank.

3. The aseptic filling device according to claim 1, wherein the filling valve and container gripper are housed within a clean booth sealed off from the outside air, a container supply intake portion to a filling unit is connected to a cleaning portion, and a container ejection portion approximates a shape of the container.

4. The aseptic filling device for carbonated beverages according to claim 2, wherein the filling valve and container gripper are housed within a clean booth sealed off from the outside air, a container supply intake portion to a filling unit is connected to a cleaning portion, and a container ejection portion approximates a shape of the container.

5. The aseptic filling device according to claim 1, wherein a shower nozzle is disposed at the top of the filling fluid tank, a cleaning fluid pipe for sanitizing the shower nozzle is connected to the shower nozzle and to the plurality of filling fluid pipes, and a switching valve is provided on the plurality of filling fluid pipes for switching between filling fluid and cleaning fluid.

6. The aseptic filling device according to claim 2, wherein a shower nozzle is disposed at the top of the filling fluid tank, a cleaning fluid pipe for sanitizing the shower nozzle is connected to the shower nozzle and to the plurality of filling fluid pipes, and a switching valve is provided on the plurality of filling fluid pipes for switching between filling fluid and cleaning fluid.

7. The aseptic filling device according to claim 3, wherein a shower nozzle is disposed at the top of the filling fluid tank, a cleaning fluid pipe for sanitizing the shower nozzle is connected to the shower nozzle and to the plurality of filling fluid pipes, and a switching valve is provided on the plurality of filling fluid pipes for switching between filling fluid and cleaning fluid.

8. The aseptic filling device according to claim 1, wherein the plurality of filling valves are installed at a top portion of the rotating body.

9. The aseptic filling device according to claim 1, wherein the exhaust conduit on/off valve is configured to open and close one exhaust conduit.

10. The aseptic filling device according to claim 1, wherein the counter gas conduit on/off valve is configured to open and close one counter gas conduit.
